(19) United States
(12) Patent Application Publication
(10) Pub. No.: US 2026/0067467 A1
(43) Pub. Date: Mar. 5, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 18/877,920

(22) PCT Filed: Aug. 22, 2023
(86) PCT No.: PCT/KR2023/012415

§ 371 Date: Nov. 4, 2025

(30) Foreign Application Priority Data
Aug. 22, 2022 (KR) 10-2022-0104703
Aug. 22, 2023 (KR) 10-2023-0109738

(51) Int. Cl. H04N 19/139; H04N 19/119; H04N 19/176

(52) U.S. Cl. CPC H04N 19/139; H04N 19/119; H04N 19/176

(57) ABSTRACT

An image decoding method may comprise partitioning a current block into a first partition and a second partition according to a partitioning boundary, determining a first base motion vector and a second base motion vector corresponding to the first partition and the second partition, determining a first refined motion vector and a second refined motion vector by refining the first base motion vector and the second base motion vector, determining a first prediction block for the first partition and a second prediction block for the second partition according to the first refined motion vector and the second refined motion vector, and determining a final prediction block based on the first prediction block and the second prediction block.

### TECHNICAL FIELD

The present invention relates to an image encoding/decoding method and apparatus and a recording medium for storing a bitstream. More particularly, the present invention relates to an image encoding/decoding method and apparatus using an inter prediction method and a recording medium for storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In inter prediction, a method of partitioning a coding unit block into partitions having various shapes and predicting each partition according to different motion information has been discussed. At this time, various methods for accurately predicting a mixed area of partitioning boundaries of partitions have been discussed.

### DISCLOSURE

### Technical Problem

An object of the present invention is to provide an image encoding/decoding method and apparatus with improved encoding/decoding efficiency.

Another object of the present invention is to provide a recording medium for storing a bitstream generated by an image decoding method or apparatus provided by the present invention.

### Technical Solution

A image decoding method according to an embodiment of the present invention may comprise partitioning a current block into a first partition and a second partition according to a partitioning boundary, determining a first base motion vector and a second base motion vector corresponding to the first partition and the second partition, determining a first refined motion vector and a second refined motion vector by refining the first base motion vector and the second base motion vector, determining a first prediction block for the first partition and a second prediction block for the second partition according to the first refined motion vector and the second refined motion vector and determining a final prediction block based on the first prediction block and the second prediction block.

According to one embodiment, in the determining of the first refined motion vector and the second refined motion vector, the first refined motion vector and the second refined motion vector may be determined according to a distance between a current picture including the current block and a first reference picture referenced by the first partition and a distance between the current picture and a second reference picture referenced by the second partition.

According to one embodiment, a magnitude of a first differential motion vector representing a difference between the first base motion vector and the first refined motion vector and a magnitude of a second differential motion vector between the second base motion vector and the second refined motion vector may be proportional to a distance between the current picture and the first reference picture and a distance between the current picture and the second reference picture.

According to one embodiment, the magnitudes of the first differential motion vector and the second differential motion vector may be limited within a predetermined range.

According to one embodiment, in the determining of the first refined motion vector and the second refined motion vector, the first refined motion vector and the second refined motion vector may be determined such that distortion between the first prediction block indicated by the first refined motion vector and the second prediction block indicated by the second refined motion vector is minimized.

According to one embodiment, in the determining of the final prediction block, the final prediction block may be determined according to a weighted sum of the first prediction block and the second prediction block.

According to one embodiment, the weighted sum of the first prediction block and the second prediction block may be determined by a first weighted value determined according to a difference between a current picture including the current block and a first reference picture referenced by the first partition and a second weighted value determined according to a distance between the current picture and a second reference picture referenced by the second partition.

According to one embodiment, the first weighted value applied to the first prediction block may be proportional to the distance between the current picture and the second reference picture, and the second weighted value applied to the second prediction block may be proportional to the distance between the current picture and the first reference picture.

According to one embodiment, in the determining of the first base motion vector and the second base motion vector, a first L0 base motion vector and a first L1 base motion vector corresponding to the first partition may be determined and a second L0 base motion vector and a second L1 base motion vector corresponding to the second partition may be determined.

According to one embodiment, in the determining of the first refined motion vector and the second refined motion vector, a first L0 refined motion vector and a first L1 refined motion vector may be determined by refining the first L0 base motion vector and the first L1 base motion vector and a second L0 refined motion vector and a second L1 refined motion vector may be determined by refining the second L0 base motion vector and the second L1 base motion vector.

According to one embodiment, in the determining of the first prediction block and the second prediction block, the first prediction block may be determined according to the first L0 refined motion vector and the first L1 refined motion vector and the second prediction block may be determined according to the second L0 refined motion vector and the second L1 refined motion vector.

According to one embodiment, in the determining of the first L0 refined motion vector, the first L1 refined motion vector, the second L0 refined motion vector and the second L1 refined motion vector, the first L0 refined motion vector and the first L1 refined motion vector may be determined according to a distance between a current picture including the current block and a first L0 reference picture referenced by the first partition and a distance between the current picture and a first L1 reference picture referenced by the first partition, and

According to one embodiment, the second L0 refined motion vector and the second L1 refined motion vector may be determined according to a distance between the current picture and a second L0 reference picture referenced by the second partition and a distance between the current picture and a second L1 reference picture referenced by the second partition.

According to one embodiment, a magnitude of a first L0 differential motion vector representing a difference between the first L0 base motion vector and the first L0 refined motion vector and a magnitude of a first L1 differential motion vector representing the first L1 base motion vector and the first L1 refined motion vector may be proportional to a distance between the current picture and the first L0 reference picture and a distance between the current picture and the first L1 reference picture, and

According to one embodiment, a magnitude of a second L0 differential motion vector representing a difference between the second L0 base motion vector and the second L0 refined motion vector and a magnitude of a second L1 differential motion vector representing a difference between the second L1 base motion vector and the second L1 refined motion vector may be proportional to a distance between the current picture and the second L0 reference picture and a difference between the current picture and the second L1 reference picture.

According to one embodiment, the magnitudes of the first L0 differential motion vector, the first L1 differential motion vector, the second L0 differential motion vector and the second L1 differential motion vector may be limited within a predetermined range.

According to one embodiment, the determining the first prediction block and the second prediction block may comprise determining a first L0 prediction block and a first L1 prediction block according to the first L0 refined motion vector and the first L1 refined motion vector and determining a second L0 prediction block and a second L1 prediction block according to the second L0 refined motion vector and the second L1 refined motion vector, and determining the first prediction block according to a weighted sum of the first L0 prediction block and the first L1 prediction block and determining the second prediction block according to a weighted sum of the second L0 prediction block and the second L1 prediction block.

According to one embodiment, in the determining of the first L0 refined motion vector and the first L1 refined motion vector, the first L0 refined motion vector and the first L1 refined motion vector may be determined such that distortion between the first L0 prediction block indicated by the first L0 refined motion vector and the first L1 prediction block indicated by the first L1 refined motion vector is minimized, and

According to one embodiment, in the determining of the second L0 refined motion vector and the second L1 refined motion vector, the second L0 refined motion vector and the second L1 refined motion vector may be determined such that distortion between the second L0 prediction block indicated by the second L0 refined motion vector and the second L1 prediction block indicated by the second L1 refined motion vector is minimized.

An image encoding method according to an embodiment of the present invention may comprise partitioning a current block into a first partition and a second partition according to a partitioning boundary, determining a first base motion vector and a second base motion vector corresponding to the first partition and the second partition, determining a first refined motion vector and a second refined motion vector by refining the first base motion vector and the second base motion vector, determining a first prediction block for the first partition and a second prediction block for the second partition according to the first refined motion vector and the second refined motion vector, and determining a final prediction block based on the first prediction block and the second prediction block.

A non-transitory computer-readable recording medium according to one embodiment of the present invention stores a bitstream generated by the image encoding method.

A transmission method according to one embodiment of the present invention transmits a bitstream generated by the image encoding method.

The features briefly summarized above with respect to the present disclosure are merely exemplary aspects of the detailed description below of the present disclosure, and do not limit the scope of the present disclosure.

### Advantageous Effects

The present invention proposes various embodiments of a method of applying decoder-side motion vector refinement in a geometric partitioning mode to improve prediction accuracy of inter prediction.

In addition, the present invention proposes various embodiments of applying bidirectional prediction to each partition in a geometric partitioning mode to improve prediction accuracy of inter prediction.

In the present invention, as accuracy of inter prediction is improved, the overall encoding efficiency can be improved.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 shows an embodiment of a method of determining one of various inter prediction methods in an inter prediction mode.

FIG. 5 shows an embodiment of decoder-side motion vector refinement in a geometric partitioning mode.

FIG. 6 shows an embodiment of decoder-side motion vector refinement in a geometric partitioning mode in which bidirectional prediction is applied to each partition.

FIG. 7 shows an embodiment of decoder-side motion vector refinement in a geometric partitioning mode when a temporal distance between a current picture and an L0 reference picture and a temporal distance between the current picture and an L1 reference picture are not the same.

FIG. 8 shows an embodiment of decoder-side motion vector refinement in a geometric partitioning mode in which bidirectional prediction is applied to each partition when a temporal distance between a current picture and an L0 reference picture and a temporal distance between the current picture and an L1 reference picture are not the same.

FIG. 9 shows a method of generating a final prediction block by considering the characteristics of a bidirectionally predicted geometric partitioning mode.

FIG. 10 is a flowchart of an embodiment of a decoder-side motion vector refinement method of a geometric partitioning mode according to the present invention.

FIG. 11 exemplary illustrates a content streaming system to which an embodiment according to the present invention is applicable.

### BEST MODE

An image decoding method according to an embodiment of the present invention may comprise partitioning a current block into a first partition and a second partition according to a partitioning boundary, determining a first base motion vector and a second base motion vector corresponding to the first partition and the second partition, determining a first refined motion vector and a second refined motion vector by refining the first base motion vector and the second base motion vector, determining a first prediction block for the first partition and a second prediction block for the second partition according to the first refined motion vector and the second refined motion vector, and determining a final prediction block based on the first prediction block and the second prediction block.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term is and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

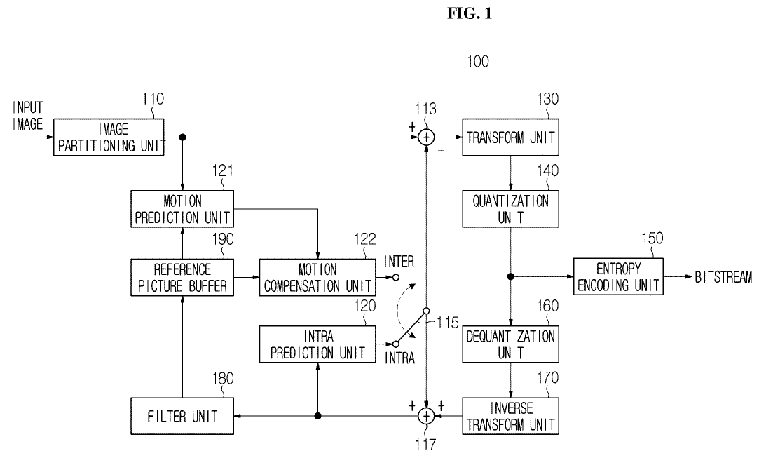

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or 4 sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

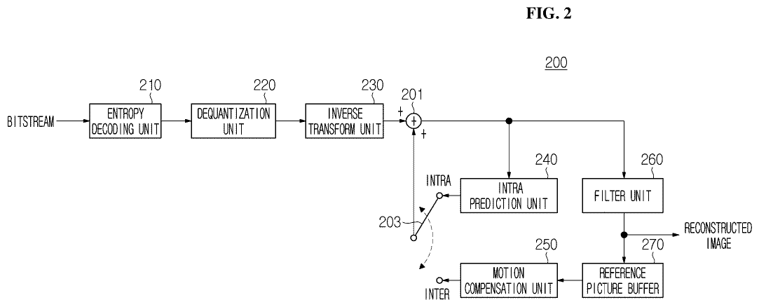

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

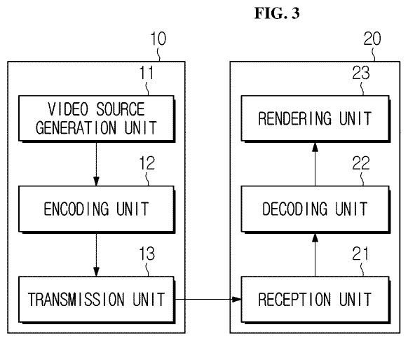

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

In the present invention, a method of applying decoder-side motion vector refinement to a geometric partitioning mode is provided.

The geometric partitioning mode (GPM) is a technology that partitions a coding unit (CU) into two partitions by a partitioning boundary, independently determines prediction signals corresponding to the two partitions, and then generates a final prediction block by a weighted sum of the generated prediction signals. Decoder-side motion vector refinement (DMVR) is a technology that refines a motion vector in a decoder without separate encoding information.

In the geometric partitioning mode, a current block is partitioned into two partitions by a straight-line partitioning boundary. Then, according to inter-inter prediction or intra-inter prediction, prediction blocks for the two partitioned areas are generated. Then, the prediction block of the current block is generated by a weighted sum of the prediction signals of the two prediction blocks.

In inter-inter prediction in the geometric partitioning mode, the two partitions have independent motion information. In addition, according to each independent motion information, the inter prediction signal of each area is generated. At this time, unidirectional motion compensation or bi-directional motion compensation is performed on each partition.

In intra-inter prediction of the geometric partitioning mode, one of the two partitions is predicted by intra prediction, and the other partition is predicted by inter prediction. At this time, the partition using inter prediction is predicted according to unidirectional motion compensation or bidirectional motion compensation.

When only unidirectional motion compensation is used for a partition, a merge candidate list of a geometric partitioning mode that includes only unidirectional motion information is constructed. That is, among regular merge candidate lists, a merge candidate list that only has unidirectional motion information may be generated by using the motion information of an L0 list for candidates whose merge indices are even and the motion information of an L1 list for candidates whose merge indices are odd. Conversely, the motion information of the L1 list may be used for candidates whose merge indices are even, and the motion information of the L0 list may be used for candidates whose merge indices are odd. Among the generated merge candidate lists, inter prediction may be performed on a partition according to a merge candidate for a partition that uses inter prediction.

Depending on the embodiment, only bidirectional motion compensation may be used for each partition. At this time, the merge candidates of the partition may include both motion information for the L0 direction and motion information for the L1 direction, respectively. The merge candidate list of each partition may be determined independently. Alternatively, two partitions may share a merge candidate list, but the partitions may be set to refer to different merge candidates.

Decoder-side motion vector refinement is a method of refining a bidirectional motion vector by searching for motion based on bilateral matching (BM) in the process of decoding the bidirectional motion vector. In order to refine the motion vector, the surroundings of a reference picture are searched from an initial motion vector. At this time, a motion vector that minimizes the degree of distortion of two reference blocks based on bilateral matching is searched.

Hereinafter, various intra prediction modes applied in intra prediction will be described. In addition, the conditions under which decoder-side motion vector refinement is applied to the regular merge mode and geometric partitioning mode will be described.

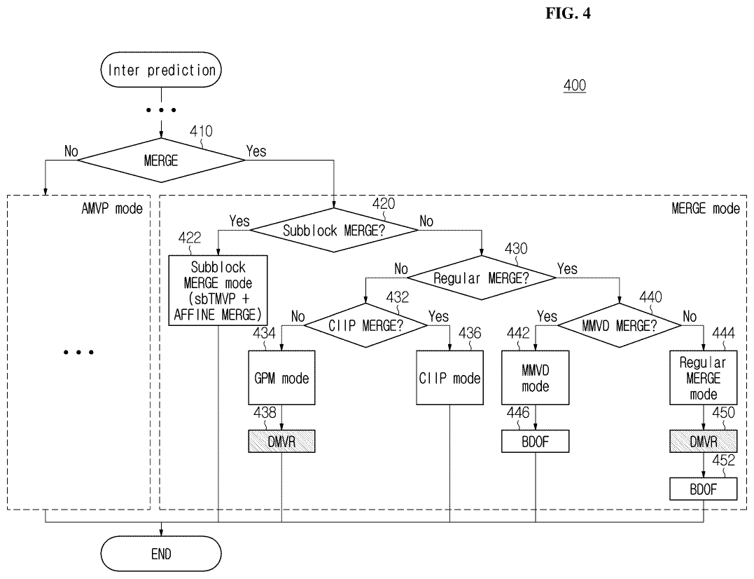

FIG. 4 shows an embodiment 400 of a method of determining one of various inter prediction methods in an inter prediction mode.

According to the embodiment 400, when a current block is predicted and encoded or decoded by inter prediction, in step 410, it is determined whether the inter prediction mode of the current block is a merge mode or an AMVP (Advanced Motion Vector Prediction) mode.

The merge mode is an inter prediction mode in which motion information such as the motion vector and reference picture of the current block is obtained from the adjacent blocks of the current block. On the other hand, according to the AMVP mode, the prediction motion vector is obtained from the adjacent blocks of the current block, and other motion information such as the differential motion vector and reference picture information excluding a prediction motion vector is obtained by parsing a bitstream. Therefore, the AMVP mode is different from the merge mode in which the motion information of the neighboring blocks is all used for prediction of the current block.

If the inter prediction mode of the current block is the merge mode, it is determined in step 420 whether the inter prediction mode of the current block is a subblock merge mode. If the inter prediction mode of the current block is the subblock merge mode, in step 422, the current block is partitioned into a plurality of subblocks according to the subblock merge mode, and each subblock may be predicted based on a motion vector according to affine transform.

If the inter prediction mode of the current block is not the subblock merge mode, in step 430, it is determined whether the inter prediction mode of the current block is a regular merge mode. If the inter prediction mode of the current block is not the regular merge mode, in step 432, it is determined whether the inter prediction mode of the current block is a combined intra inter prediction (CIIP) mode.

If the inter prediction mode of the current block is not the intra-inter prediction mode, in step 434, the inter prediction mode of the current block is determined to be a geometric partitioning mode. The geometric partitioning mode is an inter prediction mode that partitions the current block into two partitions based on a predetermined boundary and determines a final prediction block of the current block by combining two prediction blocks for the two partitions. In step 436, the inter prediction mode of the current block is determined to be a combined intra inter prediction mode. According to the combined intra inter prediction mode, the final prediction block of the current block may be determined by combining the prediction block according to the intra prediction of the current block and the prediction block according to the inter prediction of the current block.

If the geometric partitioning mode is applied to the current block, when a certain condition is satisfied, the motion vector of the current block may be refined according to the decoder-side motion vector refinement mode in step 438.

If the inter prediction mode of the current block is the regular merge mode, it is determined in step 440 whether the inter prediction mode of the current block is a merge mode with motion vector difference (MMVD). According to the merge mode with motion vector difference, a refined motion vector of the current block is determined by adding a differential motion vector to a motion vector obtained from a neighboring block. In the merge mode with motion vector difference, the direction of the differential motion vector may be limited to one of +x, −x, +y, and −y. In addition, in the merge mode with motion vector difference, the magnitude of the differential motion vector may be limited to being selected from a limited number of predetermined magnitude candidates.

If the inter prediction mode of the current block is the merge mode with motion vector difference, the current block is predicted according to the merge mode with motion vector difference. In addition, if the current block is bidirectionally predicted, the prediction block of the current block may be adjusted by a bidirectional optical flow (BDOF) mode in step 446.

If the inter prediction mode of the current block is not the merge mode with motion vector difference, the regular merge mode is applied to the current block in step 444. In addition, if the current block is bidirectionally predicted, the motion vector of the current block may be refined according to the decoder-side motion vector refinement mode in step 450. In addition, in step 452, similar to step 446, the prediction block of the current block may be adjusted by the bidirectional optical flow mode.

Decoder-side motion vector refinement is a method of refining a motion vector through a bilateral matching-based motion vector search process without parsing additional information, in decoding the bidirectional motion vector derived in the regular merge mode. According to decoder-side motion vector refinement, the accuracy of the motion vector in the regular merge mode can be improved. In addition, accordingly, the encoding efficiency of the regular merge mode can be improved.

Although, in FIG. 4, the decoder-side motion vector refinement mode is described as being applied only to the regular merge mode, depending on the embodiment, the decoder-side motion vector refinement mode may also be applied to the subblock merge mode, the geometric partitioning mode, the combined intra inter prediction mode, and the merge mode with motion vector difference.

Based on the flag information parsed from the bitstream, the inter prediction mode of the current block may be determined in steps 410, 420, 430, 432, and 440 of FIG. 4. For example, in steps 410, 420, 430 and 440, a merge flag, a subblock merge flag, a regular merge flag, a combined intra inter prediction flag, and a merge mode with motion vector difference flag may be parsed from the bitstream, respectively.

Hereinafter, the application conditions of decoder-side motion vector refinement of steps 438 and 450 will be described.

According to one embodiment, when a coding unit (CU) block is in a merge mode, decoder-side motion vector refinement may be applied. In addition, when a coding unit block is not in a subblock merge mode to which inter prediction according to affine transform is applied, decoder-side motion vector refinement may be applied. In addition, when merge mode with motion vector difference (MMVD) is not applied to a coding unit block, decoder-side motion vector refinement may be applied. In addition, when a coding unit block is in a geometric partitioning mode to which bidirectional prediction is applied, decoder-side motion vector refinement may be applied.

According to one embodiment, when the coding unit block is in a bi-directional prediction mode, decoder-side motion vector refinement may be applied. Furthermore, according to one embodiment, when two reference pictures referenced by the coding unit block are respectively located in temporally opposite directions from the current picture, decoder-side motion vector refinement may be applied. For example, when a first reference picture among the two reference pictures temporally precedes the current picture and a second reference picture temporally follows the current picture, decoder-side motion vector refinement may be applied.

According to one embodiment, when temporal distances between the two reference pictures and the current picture are the same, decoder-side motion vector refinement may be applied. The temporal distance may mean the magnitude of a POC (Picture Order Count) difference between the reference picture and the current picture. In the present invention, the distance between pictures represents the temporal distance and the magnitude of the POC difference.

Depending on the embodiment, decoder-side motion vector refinement may be applied even when the temporal distances between the two reference pictures and the current picture are different in the regular merge mode. By not applying the condition of the same temporal distance, decoder-side motion vector refinement may be applied more in the regular merge mode. Accordingly, encoding efficiency can be improved as decoder-side motion vector refinement is performed more by relaxation of the performance condition. However, in the case of the geometric partitioning mode, decoder-side motion vector refinement may be set to be applied only when the temporal distances between the two reference pictures and the current picture are the same.

Depending on the embodiment, decoder-side motion vector refinement may be applied even when the temporal distances between the two reference pictures and the current picture are different in the geometric partitioning mode. By not applying the condition of the same temporal distance, decoder-side motion vector refinement may be applied more in the geometric partitioning mode. Accordingly, encoding efficiency can be improved as decoder-side motion vector refinement is performed more by relaxation of the performance condition. However, in the case of the regular merge mode, decoder-side motion vector refinement may be set to be applied only when the temporal distances between the two reference pictures and the current picture are the same.

Depending on the embodiment, for the regular merge mode and the geometric partitioning mode, decoder-side motion vector refinement may be applied even when the temporal distances between the two reference pictures and the current picture are different. Accordingly, since decoder-side motion vector refinement is applied to the two prediction modes without the restriction of the temporal distance condition, encoding efficiency can be improved.

According to one embodiment, when two reference pictures are short-term reference pictures, decoder-side motion vector refinement may be applied.

According to one embodiment, whether to apply decoder-side motion vector refinement may be determined according to the size of the coding unit block. For example, when the size of the coding unit block is larger than a predetermined size, decoder-side motion vector refinement may be applied. The predetermined size may be expressed as the number of luma samples included in the coding unit block. In addition, the predetermined size may be a power of 2, such as 64, 128, 256, 512, or 1024.

According to one embodiment, whether to apply decoder-side motion vector refinement may be determined according to the width and height of the coding unit block. For example, when the height and/or width of the coding unit block is larger than a predetermined value, decoder-side motion vector refinement may be applied. The predetermined value may be a power of 2, such as 4, 8, 16, or 32.

According to one embodiment, when the bidirectional coding unit weighted values applied to two prediction blocks of the coding unit block are the same, decoder-side motion vector refinement may be applied. The final prediction block of the coding unit block is determined to be a weighted average of two prediction blocks obtained from bidirectional prediction. At this time, the bidirectional coding unit weighted values are used to determine the weighted average of the two prediction blocks. However, depending on the embodiment, decoder-side motion vector refinement may be set to be applied even when the bidirectional coding unit weighted values applied to the two prediction blocks are different.

According to one embodiment, when the coding unit block is a bidirectionally predicted regular merge mode and bidirectional coding unit weighted values of the coding unit block are the same, decoder-side motion vector refinement may be applied. If the coding unit block is not in the regular merge mode, decoder-side motion vector refinement may be applied even if the bidirectional coding unit weighted values are not the same. For example, when the geometric partitioning mode is applied to the coding unit block, decoder-side motion vector refinement may be applied regardless of whether the bidirectional coding unit weighted values are the same.

According to one embodiment, when combined intra inter prediction (CIIP) is not applied, decoder-side motion vector refinement may be applied. Combined intra inter prediction is a prediction method of determining a final prediction block by a weighted average of a first prediction block derived from intra prediction and a second prediction block derived from inter prediction for one block.

According to one embodiment, at least one of the above-described multiple conditions may be included in the conditions for performing decoder-side motion vector refinement.

As the conditions for performing decoder-side motion vector refinement increase, the frequency of decoder-side motion vector refinement may decrease. Conversely, as the conditions for performing decoder-side motion vector refinement decrease, the frequency of decoder-side motion vector refinement may increase. Accordingly, the frequency of motion vector refinement and the encoding efficiency of the merge mode may be determined according to the conditions for decoder-side motion vector refinement.

Hereinafter, a method of performing decoder-side motion vector refinement in a geometric partitioning mode will be described.

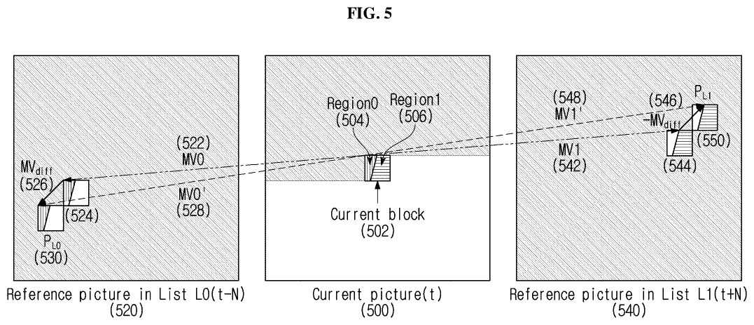

FIG. 5 shows an embodiment of decoder-side motion vector refinement in a geometric partitioning mode.

A current picture 500 includes a current block 502. In addition, the current block 502 includes a first partition 504 and a second partition 506. According to one embodiment, the first partition 504 and the second partition 506 may be unidirectionally predicted, respectively.

The current picture 500 and the L0 reference picture 520 have a POC distance of N. In addition, the current picture 500 and the L1 reference picture 540 also have a POC distance of N. Therefore, a distance between the current picture 500 and the L0 reference picture 520 and a distance between the current picture 500 and the L1 reference picture 540 are the same.

Based on the motion information of neighboring blocks, base motion vectors MV0 522 and MV1 542 in the L0 and L1 directions for the current block 502 applied to the geometric partitioning mode may be obtained. MV0 522 represents an initial reference block 524 corresponding to the first partition 504. In addition, MV1 542 represents an initial reference block 544 corresponding to the second partition 506, respectively. In some cases, there may be a reference block more suitable for the prediction of the current block around the initial reference blocks 524 and 544, and a motion vector indicating a more suitable reference block is searched based on bilateral matching.

MV0 522 and MV1 542 are the base motion vectors in the L0 and L1 directions derived according to the geometric partitioning mode, respectively. MV0′ 528 is a motion vector obtained by refining MV0 522, the base motion vector in the L0 direction, by MV_{diff} 526. In addition, MV1′ 548 is a motion vector obtained by refining MV1 542, the base motion vector in the L1 direction, by −MV_{diff} 546. MV_{diff} 526 and −MV_{diff} 546 are the L0 differential motion vector and the L1 differential motion vector, respectively. The L0 differential motion vector and the L1 differential motion vector have the same magnitude, but their directions are set opposite.

If distortion between the reference block indicated by MV0′ 528 in the L0 reference picture 520 and the reference block indicated by MV1′ 548 in the L1 reference picture 540 is minimized, MV0′ 528 and MV1′ 548 may be determined to be a refined motion vector of the current block 502. At this time, various distortion measurement methods, such as a sum of absolute difference (SAD) or a sum of squared error (SSE) between the two reference blocks, may be used.

Finally, when MV0′ 528 and MV1′ 548 are the refined motion vectors with the minimum distortion, the two prediction blocks P_{L0} 530 and P_{L1} 550 are determined using the refined motion vectors MV0′ 528 and MV1′ 548.

Although, in FIG. 5, the unidirectional motion vector of the first partition 504 is described as being in the L0 direction, and the unidirectional motion vector of the second partition 506 is described as being in the L1 direction, depending on the embodiment, the unidirectional motion vector of the first partition 504 may be determined to be in the L1 direction, and the unidirectional motion vector of the second partition 506 may be determined to be in the L0 direction.

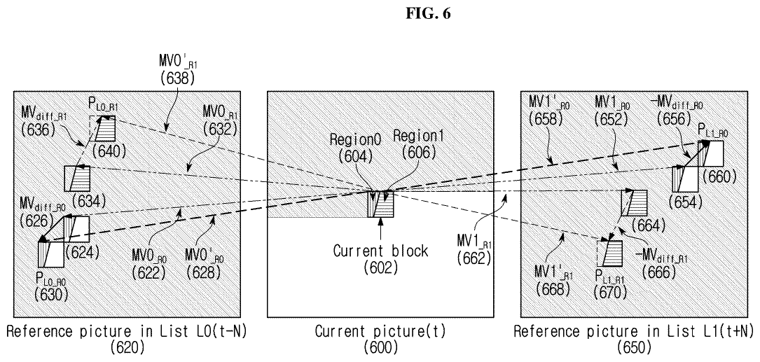

FIG. 6 shows an embodiment of decoder-side motion vector refinement in a geometric partitioning mode in which bidirectional prediction is applied to each partition.

A current picture 600 includes a current block 602. In addition, the current block 602 includes a first partition 604 and a second partition 606.

The current picture 600 and an L0 reference picture 620 have a POC distance of N. In addition, the current picture 600 and an L1 reference picture 650 also have a POC distance of N. Therefore, a distance between the current picture 600 and the L0 reference picture 620 and a distance between the current picture 600 and the L1 reference picture 650 are the same.

According to one embodiment, bidirectional motion prediction may be performed on each of the first partition 604 and the second partition 606. In the embodiment of FIG. 5, where each partition is predicted according to unidirectional motion prediction, decoder-side motion vector refinement may be performed on the first partition 504 and the second partition 506 by considering the entire area of the current block 502. On the other hand, in the embodiment of FIG. 6, where each partition is predicted according to bidirectional motion prediction, decoder-side motion vector refinement may be performed by considering only the area of each partition.

For bidirectional motion prediction of the first partition 604, the motion vector MV0__{R0} 622 in the L0 direction and the motion vector MV1__{R0} 652 in the L1 direction are determined to be base motion vectors. In addition, for bidirectional motion prediction of the second partition 606, the motion vector MV0__{R1} 632 in the L0 direction and the motion vector MV1__{R1} 662 in the L1 direction are determined to be base motion vectors.

For motion vector refinement of the first partition 604, the neighboring motion vectors of MV0__{R0} 622 and MV1__{R0} 652 are symmetrically searched. In addition, among the multiple neighboring motion vectors, the motion vectors in the L0 and L1 directions that minimize distortion between the prediction signal in the L0 direction and the prediction signal in the L1 direction are derived to be the refined motion vectors, MV0′__{R0} 628 and MV1′__{R0} 658.

MV0′__{R0} 628 is derived by refining the motion vector MV0__{R0} 622 in the L0 direction by MV_{diff_R0} 626. In addition, MV1′__{R0} 658 is derived by refining the motion vector MV1__{R0} 652 in the L1 direction by −MV_{diff_R0} 656 to be symmetrical to the refined motion vector in the L0 direction. At this time, MV0′__{R0} 628 and MV1′__{R0} 658 that minimize distortion between the block P_{L0_R0} 630 indicated by MV0′__{R0} 628 in the L0 reference picture 620 and the block P_{L1_R0} 660 indicated by MV1′__{R0} 658 in the L1 reference picture 650 are determined to be the refined motion vectors. At this time, various distortion measurement methods such as sum of absolute difference (SAD) or sum of squared error (SSE) may be used for distortion.

The same method as the motion vector refinement of the first partition 604 described above may be applied to the motion vector refinement of the second partition 606.

For the bidirectional motion prediction of the second partition 606, the motion vector MV0__{R1} 632 in the L0 direction and the motion vector MV1__{R1} 662 in the L1 direction are determined to be the base motion vectors.

For motion vector refinement of the second partition 606, the neighboring motion vectors of MV0__{R1} 632 and MV1__{R1} 662 are symmetrically searched. In addition, among the multiple neighboring motion vectors, the motion vectors in the L0 and L1 directions that minimize distortion between the prediction signal in the L0 direction and the prediction signal in the L1 direction are derived to be the refined motion vectors, MV0′__{R1} 638 and MV1′__{R1} 668.

MV0′__{R1} 638 is derived by refining the motion vector MV0__{R1} 632 in the L0 direction by MV_{diff_R1} 636. In addition, MV1′__{R1} 668 is derived by refining the motion vector MV1__{R1} 662 in the L1 direction by −MV_{diff_R1} 666 to be symmetrical to the refined motion vector in the L0 direction. At this time, MV0′__{R1} 638 and MV1′__{R1} 668 that minimize distortion between the block P_{L0_R1} 640 indicated by MV0′__{R1} 638 in the L0 reference picture 620 and the block P_{L1_R1} 670 indicated by MV1′__{R1} 668 in the L1 reference picture 650 are determined to be the refined motion vectors. At this time, various distortion measurement methods such as a sum of absolute difference (SAD) or a sum of squared error (SSE) may be used for distortion.

In FIG. 6, the reference pictures of the first partition 604 and the second partition 606 are described as being the same as the L0 reference picture 620 and the L1 reference picture 640. However, the reference pictures of the first partition 604 and the second partition 606 may be different from each other.

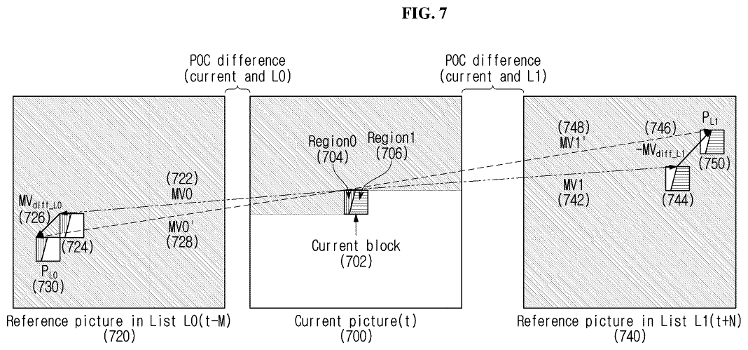

FIG. 7 shows an embodiment of decoder-side motion vector refinement of a geometric partitioning mode when a temporal distance between a current picture and an L0 reference picture and a temporal distance between the current picture and an L1 reference picture are not the same.

A current picture 700 includes a current block 702. In addition, the current block 702 includes a first partition 704 and a second partition 706. According to one embodiment, the first partition 704 and the second partition 706 may be unidirectionally predicted, respectively.

In FIG. 7, the current picture 700 is a picture at time t, and an L0 reference picture 720 and an L1 reference picture 740 are pictures at time t−M (t−M>0) and time t+N (t+N>0), respectively (t−M<t+N). Here, M and N are different (M<N) arbitrary positive integer values. Therefore, a temporal distance between the L0 reference picture 720 and the current picture 700 and a temporal distance between the L1 reference picture 740 and the current picture 700 are not the same.

According to FIG. 7, the L0-direction motion vector MV0 722 and the L1-direction motion vector MV1 742 derived in the geometric partitioning mode are base motion vectors. MV0 722 and MV1 742 indicate the initial reference blocks 724 and 744, respectively. In addition, the motion vector MV0′ 728 is determined by refining MV0 722 by MV_{diff_L0} 726. Then, the motion vector MV1′ 748 is determined by refining MV1 742 by MV_{diff_L1} 746. MV_{diff_L1} 746 may be determined from MV_{diff_L0} 726 by considering a ratio of the temporal distance between the current picture and the L0 reference picture and the temporal distance between the current picture and the L1 reference picture. The motion vectors MV0′ 728 and MV1′ 748 may be derived to be the refined motion vectors in the L0 direction and the L1 direction, respectively, when distortion between a block P_{L0} 730 and a block P_{L1} 750 is the smallest. Equation 1 shows a method of calculating MV_{diff_L1} corresponding to MV_{diff_L0} by considering the ratio of the temporal distance between the current picture and the L0 reference picture and the temporal distance between the current picture and the L1 reference picture.

$$\begin{matrix}M {V}_{diff \_ L 1 \_ x} = - \frac{N}{M} \times M {V}_{diff \_ L 0 \_ x} \\ M {V}_{diff \_ L 1 \_ y} = - \frac{N}{M} \times M {V}_{diff \_ L 0 \_ y}\end{matrix} \qquad [ Equation 1 ]$$

In Equation 1, M and N represent the temporal distance between the current picture and the L0 reference picture and the temporal distance between the current picture and the L1 reference picture, respectively. Here, M and N are different arbitrary positive integer values. In addition, in Equation 1, MV_{diff_L1_x}, MV_{diff_L1_Y}, MV_{diff_L0_x}, and MV_{diff_L0_y} represent the x-direction motion information of MV_{diff_L1}, the y-direction motion information of MV_{diff_L1}, the x-direction motion information of MV_{diff_L0}, and the y-direction motion information of MV_{diff_L0}, respectively. As seen in Equation 1, MV_{diff_L1} corresponding to MV_{diff_L0} is calculated symmetrically by considering the ratio (M:N) of the temporal distance between the current picture and the L0 reference picture and the temporal distance between the current picture and the L1 reference picture. The motion vector MV1′, which is obtained by refining the final L1-direction motion vector MV1 by the calculated MV_{diff_L1} (MV_{diff_L1_x} and MV_{diff_L1_y}), may be derived to be the refined motion vector in the L1 direction. In Equation 1, the motion information of MV_{diff_L1} is calculated by reflecting the ratio of the temporal distance between the current picture and the L0 reference picture and the temporal distance between the current picture and the L1 reference picture in the motion information of MV_{diff_L0}. Conversely, the motion information of MV_{diff_L0} may also be calculated by reflecting the ratio of the temporal distance between the current picture and the L0 reference picture and the temporal distance between the current picture and the L1 reference picture in the motion information of MV_{diff_L1}.

MV_{diff_L1_x} and MV_{diff_L1_y} determined in Equation 1 are determined by multiplying MV_{diff_L0_x} and MV_{diff_L0_y} by N/M, and thus, the values of MV_{diff_L1_x} and MV_{diff_L1_y} may be non-integer values. Therefore, according to one embodiment, MV_{diff_L1_x} and MV_{diff_L1_y} may be adjusted to values in integer units. At this time, MV_{diff_L1_x} and MV_{diff_L1_y} may be integerized according to a rounding or truncation process. Alternatively, MV_{diff_L1_x} and MV_{diff_L1_y} may be adjusted to a predetermined precision other than an integer unit according to a rounding or truncation process. The predetermined precision may be ½, ¼, etc.

According to one embodiment, unlike Equation 1, MV_{diff_L1_x}, MV_{diff_L1_y}, MV_{diff_L0_x}, and MV_{diff_L0_y} may be determined without considering the ratio of the temporal distance between the current picture and the L0 reference picture and the temporal distance between the current picture and the L1 reference picture. For example, MV_{diff_L0_x} and MV_{diff_L1_x} may be set to have the same magnitude and opposite signs. In addition, MV_{diff_L0_y} and MV_{diff_L1_y} may also be set to have the same magnitude and opposite signs.

As described above, the motion vector accuracy can be improved by refining the motion vector by considering the ratio of the temporal distance between the current picture and the L0 reference picture and the temporal distance between the current picture and the L1 reference picture.

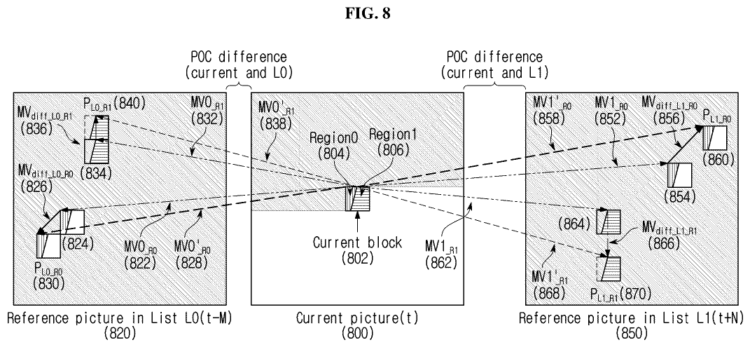

FIG. 8 shows an embodiment of decoder-side motion vector refinement in a geometric partitioning mode in which bidirectional prediction is applied to each partition, when a temporal distance between a current picture and an L0 reference picture and a temporal distance between the current picture and an L1 reference picture are not the same.

A current picture 800 includes a current block 802. In addition, the current block 802 includes a first partition 804 and a second partition 806.

In FIG. 8, the current picture 800 is a picture at time t, and the L0 reference picture 820 and the L1 reference picture 850 are pictures at time t−M (t−M>0) and time t+N (t+N>0), respectively (t−M<t+N). Here, M and N are different (M<N) arbitrary positive integer values. Therefore, a temporal distance between the L0 reference picture 820 and the current picture 800 and a temporal distance between the L1 reference picture 850 and the current picture 800 are not the same.

According to one embodiment, bidirectional motion prediction may be performed on each of the first partition 804 and the second partition 806. In the embodiment of FIG. 7, where each partition is predicted according to unidirectional motion prediction, decoder-side motion vector refinement may be performed on the first partition 704 and the second partition 706 by considering the entire area of the current block 702. On the other hand, in the embodiment of FIG. 8, where each partition is predicted according to bidirectional motion prediction, decoder-side motion vector refinement may be performed by considering only the area of each partition.

For bidirectional motion prediction of the first partition 804, the motion vector MV0__{R0} 822 in the L0 direction and the motion vector MV1__{R0} 852 in the L1 direction are determined to be base motion vectors. In addition, for bidirectional motion prediction of the second partition 806, the motion vector MV0__{R1} 832 in the L0 direction and the motion vector MV1__{R1} 862 in the L1 direction are determined to be base motion vectors.

For motion vector refinement of the first partition 804, the neighboring motion vectors of MV0__{R0} 822 and MV1__{R0} 852 are symmetrically searched. In addition, among the multiple neighboring motion vectors, the motion vectors in the L0 and L1 directions that minimize distortion between the prediction signal in the L0 direction and the prediction signal in the L1 direction are derived to be refined motion vectors, MV0′__{R0} 828 and MV1′__{R0} 858.

MV0′__{R0} 828 is derived by refining the motion vector MV0__{R0} 822 in the L0 direction by MV_{diff_L0_R0} 826. In addition, MV1′__{R0} 858 is derived by refining the motion vector MV1_R0 852 in the L1 direction by MV_{diff_L1_R0} 856 to be symmetrical to the refined motion vector in the L0 direction. MV_{diff_L1_R0} 856 may be determined from MV_{diff_L0_R0} 826 by considering a ratio of the temporal distance between the current picture and the L0 reference picture and the temporal distance between the current picture and the L1 reference picture. In this case, in determining MV_{diff_L1_R0} 856, the embodiment introduced above in relation to Equation 1 may be applied. Alternatively, MV_{diff_L1_R0} 856 may be determined to be a vector with the same magnitude in the opposite direction of MV_{diff_L0_R0} 826 without considering the ratio of the temporal distances.

At this time, MV0′__{R0} 828 and MV1′__{R0} 858 that minimize distortion between the block P_{L0_R0} 830 indicated by MV0′__{R0} 828 in the L0 reference picture 820 and the block P_{L1_R0} 860 indicated by MV1′__{R0} 858 in the L1 reference picture 850 are determined to be refined motion vectors. At this time various distortion measurement methods such as a sum of absolute difference (SAD) or a sum of squared error (SSE) may be used for distortion.

The same method as the motion vector refinement of the first partition 804 described above may be applied to the motion vector refinement of the second partition 806.

For bidirectional motion prediction of the second partition 806, the motion vector MV0__{R1} 832 in the L0 direction and the motion vector MV1__{R1} 862 in the L1 direction are determined to be base motion vectors.

For motion vector refinement of the second partition 806, the neighboring motion vectors of MV0__{R1} 832 and MV1__{R1} 862 are symmetrically searched. In addition, among the multiple neighboring motion vectors, the motion vectors in the L0 and L1 directions that minimize distortion between the prediction signal in the L0 direction and the prediction signal in the L1 direction are derived to be refined motion vectors, MV0′__{R1} 838 and MV1′__{R1} 868.

MV0′__{R1} 838 is derived by refining the motion vector MV0__{R1} 832 in the L0 direction by MV_{diff_L0_R1} 836. In addition, MV1′__{R1} 868 is derived by refining the motion vector MV1__{R1} 862 in the L1 direction by MV_{diff_L1_R1} 866 to be symmetrical to the refined motion vector in the L0 direction. MV_{diff_L1_R1} 866 may be determined from MV_{diff_L0_R1} 836 by considering a ratio of a temporal distance between the current picture and the L0 reference picture and a temporal distance between the current picture and the L1 reference picture. In this case, in determining MV_{diff_L1_R1} 866, the embodiment introduced above in relation to Equation 1 may be applied. Alternatively, MV_{diff_L1_R1} 866 may be determined to be a vector with the same magnitude in the opposite direction of MV_{diff_L0_R1} 836 without considering the ratio of the temporal distances.

At this time, MV0′__{R1} 838 and MV1′__{R1} 868 that minimize distortion between the block PL0__{R1} 840 indicated by MV0′__{R1} 838 in the L0 reference picture 820 and the block PL1_R1 870 indicated by MV1′__{R1} 868 in the L1 reference picture 850 are determined to be refined motion vectors. At this time, various distortion measurement methods such as a sum of absolute difference (SAD) or a sum of squared error (SSE) may be used for distortion.

In FIG. 8, the reference pictures of the first partition 804 and the second partition 806 are described as being the same as the L0 reference picture 820 and the L1 reference picture 840. However, the reference pictures of the first partition 804 and the second partition 806 may be different from each other.

Depending on the embodiment, unlike FIGS. 6 and 8, one of the two partitions of the current block may be unidirectionally predicted, and the other partition may be bidirectionally predicted. In this case, the decoder-side motion vector refinement presented in FIGS. 6 and 8 may be performed only on the bidirectionally predicted partition.

Hereinafter, an embodiment of a weighted value required for determining a final prediction block will be discussed.

In FIG. 5, the current picture 500 is a picture at time t, and the L0 reference picture 520 and the L1 reference picture 540 are pictures at time t−N and time t+N, respectively. The distance between the L0 reference picture 520 and the current picture 500 and the distance between the L1 reference picture 540 and the current picture 500 are equal to N. Therefore, when generating a final prediction block using the motion vector refined in the geometric partitioning mode, Equation 2 may be applied.

$${Pred}_{Final} = ( {P}_{L 0} + {P}_{L 1} + 1 ) ≫ 1 \qquad [ Equation 2 ]$$

In Equation 2, P_{L0}, P_{L1} and Pred_{Final} represent a first prediction block 530 indicated by MV0′ 528 in the L0 reference picture 520, a second prediction block 550 indicated by MV1′ 548 in the L1 reference picture 540, and a final prediction block generated using the two prediction blocks, respectively. As shown in FIG. 5, since the distances between the two reference pictures and the current picture are the same, the same weighted value may be assigned to the prediction blocks P_{L0} and P_{L1} generated from each reference picture to generate the final prediction block.

Bidirectional prediction may be applied to each of the first partition 604 and the second partition 606 as shown in FIG. 6. At this time, in determining the first prediction block according to the prediction blocks 630 and 660 of the first partition 604 and the second prediction block according to the prediction blocks 640 and 670 of the second partition 606, the method according to Equation 2 may be used.

In FIG. 7, the current picture 700 is a picture at time t, and the L0 reference picture 720 and the L1 reference picture 740 are pictures at time t−M and time t+N, respectively, and the distance between the L0 reference picture 720 and the current picture 700 and the distance between the L1 reference picture 740 and the current picture 700 are not equal to each other, which are M and N, respectively. Although the distance between the L0 reference picture 720 and the current picture 700 and the distance between the L1 reference picture 740 and the current picture 700 are not equal to each other, the final prediction block may be generated from the prediction blocks 730 and 750 of the current block 702 according to Equation 2 without considering the distance information. Alternatively, different weighted values may be applied to the prediction blocks 730 and 750 of the current block 702, by considering the difference in distance between the L0 reference picture 720 and the current picture 700 and the distance between the L1 reference picture 740 and the current picture 700.

According to one embodiment, when a bidirectionally predicted geometric partitioning mode is applied to a current block, a decoder-side motion vector refinement method may be used regardless of the bidirectional coding unit weighted value of a coding unit block. Therefore, in the case of the bidirectionally predicted geometric partitioning mode, different weighted values may be used in synthesizing prediction blocks.

According to one embodiment, a bi-prediction with CU-level weight (BCW) method using a coding unit weighted value may be applied, in order to generate a final prediction block by adaptively assigning adaptive weighted values to two prediction blocks in a bidirectionally predicted geometric partitioning mode. A prediction block may be generated by performing bidirectional prediction using various coding unit weighted values. Depending on the embodiment, five weighted values (w∈{−2, 3, 4, 5, 10}) used in a low-delay picture may be used. Alternatively, three weighted values (w∈{3, 4, 5}) used in a non-low-delay picture may be used. Alternatively, predetermined arbitrary weighted values may be used. In this case, the number of weighted values used may be arbitrarily determined.

In BCW, since information on the determined weighted values are transmitted/parsed, encoding efficiency can be reduced. Therefore, when the bidirectionally predicted geometric partitioning mode is applied to the current block and the distance between the L0 reference picture and the current picture and the distance between the L1 reference picture and the current picture are not the same, the weighted value may be derived by considering the distance ratio between each reference picture and the current picture. Equation 3 shows a weighted value determination method for the case where the distance between the L0 reference picture and the current picture and the distance between the L1 reference picture and the current picture are not the same in the case of FIG. 7.

$$\begin{matrix}Pre {d}_{Final} = {W}_{L 0} \times {P}_{L 0} + {W}_{L 1} \times {P}_{L 1} \\ {W}_{L 0} = \frac{N}{( M + N )} {W}_{L 1} = \frac{M}{( M + N )}\end{matrix} \qquad [ Equation 3 ]$$

In Equation 3, M and N represent the distance between the current picture and the L0 reference picture and the distance between the current picture and the L1 reference picture, respectively. W_{L0} and W_{L1} represent the weighted values for the prediction signal P_{L0} in the L0 direction and the weighted values for the prediction signal P_{L1} in the L1 direction, respectively. In addition, Pred_{Final} represents the final prediction block generated by applying the weighted values to the two prediction blocks.

Hereinafter, a method of generating a final prediction block, by generating prediction blocks in a shape of a partitioned area of a current block in each reference picture in consideration of the characteristics of a bidirectionally predicted geometric partitioning mode and then combining them when generating the final prediction block of the bidirectionally predicted geometric partitioning mode will be described.

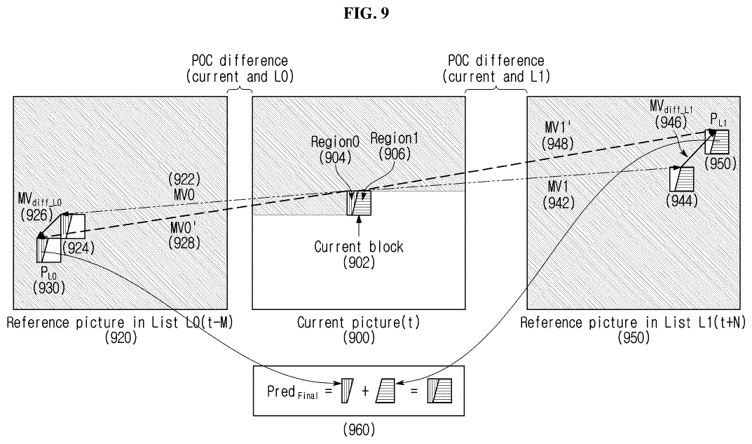

FIG. 9 shows a method of generating a final prediction block by considering the characteristics of a bidirectionally predicted geometric partitioning mode.

A decoder-side motion vector refinement method may be applied to a current block 902 together with the bidirectional predicted geometric partitioning mode. Therefore, as shown in FIG. 9, a prediction block 930 corresponding to a first partition 904 of the current block 902 is generated using a motion vector MV0′ 928 in the L0 direction. In addition, a prediction block 950 of a second partition 906 of the current block is generated using a motion vector MV1′ 948 in the L1 direction, and as indicated in a box 960, a final prediction block of the current block 902 may be generated using the prediction blocks 930 and 950 of the first partition 904 and the second partition 906.

FIG. 9 shows a method of generating a final prediction block for a bidirectionally predicted geometric partitioning mode in a case where distances between two reference pictures and the current picture are not the same. However, this may also be applied to a case where the distances between two reference pictures and the current picture are the same, as an embodiment.

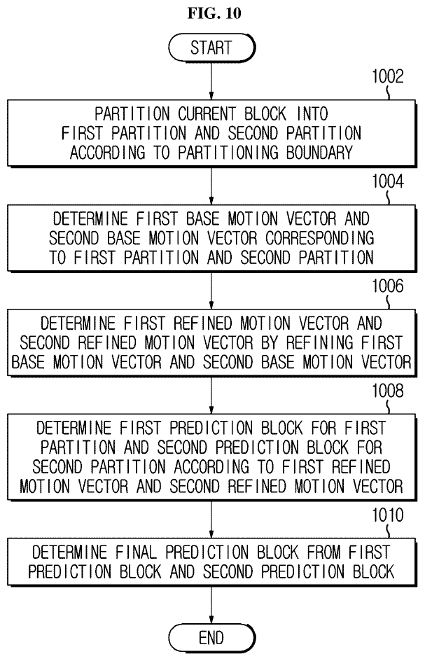

FIG. 10 is a flowchart of an embodiment of a decoder-side motion vector refinement method of a geometric partitioning mode according to the present invention.

In step 1002, a current block is partitioned into a first partition and a second partition according to a partitioning boundary.

In step 1004, a first base motion vector and a second base motion vector corresponding to the first partition and the second partition are determined.

In step 1006, a first refined motion vector and a second refined motion vector are determined by refining the first base motion vector and the second base motion vector.

According to one embodiment, in step 1006, the first refined motion vector and the second refined motion vector may be determined according to a distance between a current picture and a first reference picture referenced by the first partition and a distance between the current picture and a second reference picture referenced by the second partition.

According to one embodiment, a magnitude of a first differential motion vector representing a difference between the first base motion vector and the first refined motion vector and a magnitude of a second differential motion vector representing a difference between the second base motion vector and the second refined motion vector may be proportional to a distance between the current picture and the first reference picture and a distance between the current picture and the second reference picture. In addition, the first differential motion vector and the second differential motion vector may be in opposite directions.

According to one embodiment, the magnitudes of the first differential motion vector and the second differential motion vector may be limited within a predetermined range. Here, the predetermined range may be defined in pixel units. For example, the predetermined range may be 1 or 2 pixel units.

According to one embodiment, the first refined motion vector and the second refined motion vector may be determined such that distortion between the first prediction block indicated by the first refined motion vector and the second prediction block indicated by the second refined motion vector is minimized.

In step 1008, a first prediction block for the first partition and a second prediction block for the second partition are determined based on the first refined motion vector and the second refined motion vector.

In step 1010, a final prediction block is determined based on the first prediction block and the second prediction block.

According to one embodiment, in step 1010, the final prediction block may be determined according to a weighted sum of the first prediction block and the second prediction block. Specifically, the weighted sum of the first prediction block and the second prediction block may be determined by a first weighted value determined according to the distance between the current picture and the first reference picture referenced by the first partition, and a second weighted value determined according to the distance between the current picture and the second reference picture referenced by the second partition. Here, the first weighted value may be proportional to the distance between the current picture and the second reference picture, and the second weighted value may be proportional to the distance between the current picture and the first reference picture.

According to one embodiment, bidirectional prediction may be performed on each partition of the geometric partitioning mode. At this time, in step 1004, when bidirectional prediction is performed on the first partition, a first L0 base motion vector and a first L1 base motion vector corresponding to the first partition may be determined. Additionally, when bidirectional prediction is performed on the second partition, a second L0 base motion vector and a second L1 base motion vector corresponding to the second partition may be determined.

In step 1006, when bidirectional prediction is performed on the first partition, a first L0 refined motion vector and a first L1 refined motion vector may be determined by refining the first L0 base motion vector and the first L1 base motion vector. In addition, the first L0 refined motion vector and the first L1 refined motion vector may be determined according to the distance between the current picture and the first L0 reference picture referenced by the first partition and the distance between the current picture and the first L1 reference picture referenced by the first partition. Here, the magnitude of the first L0 differential motion vector indicating a difference between the first L0 base motion vector and the first L0 refined motion vector and the magnitude of the first L1 differential motion vector indicating a difference between the first L1 base motion vector and the first L1 refined motion vector may be proportional to the distance between the current picture and the first L0 reference picture and the distance between the current picture and the first L1 reference picture.

In addition, when bidirectional prediction is performed on the second partition, the second L0 refined motion vector and the second L1 refined motion vector may be determined by refining the second L0 base motion vector and the second L1 base motion vector. In addition, the second L0 refined motion vector and the second L1 refined motion vector may be determined according to the distance between the current picture and the second L0 reference picture referenced by the second partition and the distance between the current picture and the second L1 reference picture referenced by the second partition. Here, the magnitude of the second L0 differential motion vector indicating the difference between the second L0 base motion vector and the second L0 refined motion vector and the magnitude of the second L1 differential motion vector indicating the difference between the second L1 base motion vector and the second L1 refined motion vector may be proportional to the distance between the current picture and the second L0 reference picture and the distance between the current picture and the second L1 reference picture.

According to one embodiment, the magnitudes of the first L0 differential motion vector, the first L1 differential motion vector, the second L0 differential motion vector, and the second L1 differential motion vector may be limited within a predetermined range. Here, the predetermined range may be defined in pixel units. For example, the predetermined range may be 1 or 2 pixel units.

In step 1008, when bidirectional prediction is performed on the first partition, the first prediction block may be determined according to the first L0 refined motion vector and the first L1 refined motion vector. Additionally, when bidirectional prediction is performed on the second partition, the second prediction block may be determined according to the second L0 refined motion vector and the second L1 refined motion vector.

According to one embodiment, in step 1008, a first L0 prediction block and a first L1 prediction block may be determined according to the first L0 refined motion vector and the first L1 refined motion vector. In addition, the first prediction block may be determined according to a weighted sum of the first L0 prediction block and the first L1 prediction block. In determining the first L0 refined motion vector and the first L1 refined motion vector, the first L0 refined motion vector and the first L1 refined motion vector may be determined such that distortion between the first L0 prediction block and the first L1 prediction block is minimized.

In addition, the second L0 prediction block and the second L1 prediction block may be determined according to the second L0 refined motion vector and the second L1 refined motion vector. In addition, the second prediction block may be determined according to a weighted sum of the second L0 prediction block and the second L1 prediction block. In determining the second L0 refined motion vector and the second L1 refined motion vector, the second L0 refined motion vector and the second L1 refined motion vector may be determined such that distortion between the second L0 prediction block and the second L1 prediction block is minimized.

The decoder-side motion vector refinement method of the geometric partitioning mode described in FIG. 10 may be applied to an image decoding method and apparatus. Therefore, the motion vector may be refined in the geometric partitioning mode without separate explicit information.

The decoder-side motion vector refinement of the geometric partitioning mode described in FIG. 10 may also be applied to an image encoding method. Therefore, in the image encoding method and the image decoding method, since the same decoder-side motion vector refinement method of the geometric partitioning mode is applied, a bitstream generated in the image encoding method may be decoded according to the image decoding method.

As an image is encoded by the image encoding apparatus to which the decoder-side motion vector refinement of the geometric partitioning mode described in FIG. 10 is applied, a bitstream may be generated. In addition, the generated bitstream may be stored in a recording medium or transmitted to the image decoding apparatus. As the bitstream generated by the image decoding apparatus is decoded, the encoded image may be reconstructed.

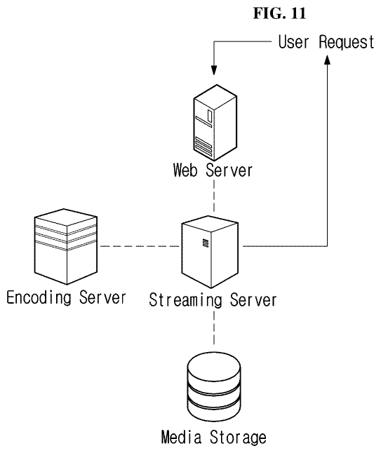

FIG. 11 exemplary illustrates a content streaming system to which an embodiment according to the present invention is applicable.

As illustrated in FIG. 11, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

1. An image decoding method comprising:
partitioning a current block into a first partition and a second partition according to a partitioning boundary;
determining a first base motion vector and a second base motion vector corresponding to the first partition and the second partition;
determining a first refined motion vector and a second refined motion vector by refining the first base motion vector and the second base motion vector;
determining a first prediction block for the first partition and a second prediction block for the second partition according to the first refined motion vector and the second refined motion vector; and
determining a final prediction block based on the first prediction block and the second prediction block.

2. The image decoding method of claim 1, wherein in the determining of the first refined motion vector and the second refined motion vector,
the first refined motion vector and the second refined motion vector are determined according to a distance between a current picture including the current block and a first reference picture referenced by the first partition and a distance between the current picture and a second reference picture referenced by the second partition.

3. The image decoding method of claim 2, wherein a magnitude of a first differential motion vector representing a difference between the first base motion vector and the first refined motion vector and a magnitude of a second differential motion vector between the second base motion vector and the second refined motion vector are proportional to a distance between the current picture and the first reference picture and a distance between the current picture and the second reference picture.

4. The image decoding method of claim 3, wherein the magnitudes of the first differential motion vector and the second differential motion vector are limited within a predetermined range.

5. The image decoding method of claim 1, wherein in the determining of the first refined motion vector and the second refined motion vector,
the first refined motion vector and the second refined motion vector are determined such that distortion between the first prediction block indicated by the first refined motion vector and the second prediction block indicated by the second refined motion vector is minimized.

6. The image decoding method of claim 1, wherein in the determining of the final prediction block, the final prediction block is determined according to a weighted sum of the first prediction block and the second prediction block.

7. The image decoding method of claim 6, wherein the weighted sum of the first prediction block and the second prediction block is determined by a first weighted value determined according to a difference between a current picture including the current block and a first reference picture referenced by the first partition and a second weighted value determined according to a distance between the current picture and a second reference picture referenced by the second partition.

8. The image decoding method of claim 7, wherein the first weighted value applied to the first prediction block is proportional to the distance between the current picture and the second reference picture, and the second weighted value applied to the second prediction block is proportional to the distance between the current picture and the first reference picture.

9. The image decoding method of claim 1,
wherein in the determining of the first base motion vector and the second base motion vector, a first L0 base motion vector and a first L1 base motion vector corresponding to the first partition are determined and a second L0 base motion vector and a second L1 base motion vector corresponding to the second partition are determined,
wherein in the determining of the first refined motion vector and the second refined motion vector, a first L0 refined motion vector and a first L1 refined motion vector are determined by refining the first L0 base motion vector and the first L1 base motion vector and a second L0 refined motion vector and a second L1 refined motion vector are determined by refining the second L0 base motion vector and the second L1 base motion vector, and
wherein in the determining of the first prediction block and the second prediction block, the first prediction block is determined according to the first L0 refined motion vector and the first L1 refined motion vector and the second prediction block is determined according to the second L0 refined motion vector and the second L1 refined motion vector.

10. The image decoding method of claim 9, wherein in the determining of the first L0 refined motion vector, the first L1 refined motion vector, the second L0 refined motion vector and the second L1 refined motion vector,
the first L0 refined motion vector and the first L1 refined motion vector are determined according to a distance between a current picture including the current block and a first L0 reference picture referenced by the first partition and a distance between the current picture and a first L1 reference picture referenced by the first partition, and
the second L0 refined motion vector and the second L1 refined motion vector are determined according to a distance between the current picture and a second L0 reference picture referenced by the second partition and a distance between the current picture and a second L1 reference picture referenced by the second partition.

11. The image decoding method of claim 10,
wherein a magnitude of a first L0 differential motion vector representing a difference between the first L0 base motion vector and the first L0 refined motion vector and a magnitude of a first L1 differential motion vector representing the first L1 base motion vector and the first L1 refined motion vector are proportional to a distance between the current picture and the first L0 reference picture and a distance between the current picture and the first L1 reference picture, and
wherein a magnitude of a second L0 differential motion vector representing a difference between the second L0 base motion vector and the second L0 refined motion vector and a magnitude of a second L1 differential motion vector representing a difference between the second L1 base motion vector and the second L1 refined motion vector are proportional to a distance between the current picture and the second L0 reference picture and a difference between the current picture and the second L1 reference picture.

12. The image decoding method of claim 11, wherein the magnitudes of the first L0 differential motion vector, the first L1 differential motion vector, the second L0 differential motion vector and the second L1 differential motion vector are limited within a predetermined range.

13. The image decoding method of claim 11, wherein the determining the first prediction block and the second prediction block comprises:
determining a first L0 prediction block and a first L1 prediction block according to the first L0 refined motion vector and the first L1 refined motion vector and determining a second L0 prediction block and a second L1 prediction block according to the second L0 refined motion vector and the second L1 refined motion vector; and
determining the first prediction block according to a weighted sum of the first L0 prediction block and the first L1 prediction block and determining the second prediction block according to a weighted sum of the second L0 prediction block and the second L1 prediction block.

14. The image decoding method of claim 13,
wherein in the determining of the first L0 refined motion vector and the first L1 refined motion vector,
the first L0 refined motion vector and the first L1 refined motion vector are determined such that distortion between the first L0 prediction block indicated by the first L0 refined motion vector and the first L1 prediction block indicated by the first L1 refined motion vector is minimized, and
wherein in the determining of the second L0 refined motion vector and the second L1 refined motion vector,
the second L0 refined motion vector and the second L1 refined motion vector are determined such that distortion between the second L0 prediction block indicated by the second L0 refined motion vector and the second L1 prediction block indicated by the second L1 refined motion vector is minimized.

15. An image encoding method comprising:
partitioning a current block into a first partition and a second partition according to a partitioning boundary;
determining a first base motion vector and a second base motion vector corresponding to the first partition and the second partition;
determining a first refined motion vector and a second refined motion vector by refining the first base motion vector and the second base motion vector;
determining a first prediction block for the first partition and a second prediction block for the second partition according to the first refined motion vector and the second refined motion vector; and
determining a final prediction block based on the first prediction block and the second prediction block.

16. A computer-readable recording medium storing a bitstream generated by an image encoding method, the image encoding method comprising:
partitioning a current block into a first partition and a second partition according to a partitioning boundary;
determining a first base motion vector and a second base motion vector corresponding to the first partition and the second partition;
determining a first refined motion vector and a second refined motion vector by refining the first base motion vector and the second base motion vector;
determining a first prediction block for the first partition and a second prediction block for the second partition according to the first refined motion vector and the second refined motion vector; and
determining a final prediction block based on the first prediction block and the second prediction block.

17. (canceled)
